(19) United States
(12) Patent Application Publication
(10) Pub. No.: US 2013/0330041 A1
(43) Pub. Date: Dec. 12, 2013

(54) WIDE-BAND OPTICAL COUPLER

(71) Applicant: FURUKAWA ELECTRIC CO., LTD., Tokyo (JP)

(72) Inventor: Kazutaka NARA, Tokyo (JP)

(73) Assignee: FURUKAWA ELECTRIC CO., LTD., Tokyo (JP)

(21) Appl. No.: 13/968,047

(22) Filed: Aug. 15, 2013

Related U.S. Application Data
(63) Continuation of application No. PCT/JP12/08038, filed on Dec. 17, 2012.

(30) Foreign Application Priority Data
Apr. 13, 2012 (JP) 2012-092260

(51) Int. Cl. G02B 6/28

(52) U.S. Cl. CPC G02B 6/2861
USPC 385/42

(57) ABSTRACT

The present invention aims to provide a low-wavelength-dependent optical coupler capable of concurrently achieving high process stability and low polarization dependence. An optical coupler 100 according to an embodiment includes a cladding layer 105 being formed on a substrate 104 and having two waveguides 101a, 101b inside. Three directional couplers 102a, 102b, 102c are each formed by bringing portions of the two waveguides close to each other in parallel, and the two delay paths 103a, 103b are each formed to give an optical path difference between the two waveguides. The delay path 103a is provided between the directional couplers 102a and 102b, and the delay path 103b is provided between the directional couplers 102b and 102c. The three directional couplers have the same coupling characteristic, and the two delay paths have different optical path differences from each other.

### CROSS-REFERENCE TO RELATED APPLICATIONS

This application is a continuation application of International Application No. PCT/JP2012/008038, filed Dec. 17, 2012, which claims the benefit of Japanese Patent Application No. 2012-092260, filed Apr. 13, 2012. The contents of the aforementioned applications are incorporated herein by reference in their entireties.

### TECHNICAL FIELD

The present invention relates to a low-wavelength-dependent optical coupler operating in a wide band.

### BACKGROUND ART

In response to recent demand for higher capacity communications, optical fibers have been laid in broader areas. In an optical fiber network (especially an access network), a 2×N optical splitter is used to provide a one-to-multiple optical fiber connection. A 2×2 optical coupler (hereinafter simply called an optical coupler) used for a 2×N optical splitter is required to operate without wavelength dependence because it needs to carry out an operation of splitting an optical signal into 50:50 in a wavelength band in which the optical coupler is used (hereinafter called a use wavelength band), specifically, in a wide wavelength band of 1.26 μm to 1.65 μm.

In this specification, being non wavelength dependent or low wavelength dependent means that the split ratio (also called the coupling efficiency) does not vary largely even in the case of inputting an optical signal at any wavelength at least in the wavelength band of 1.26 μto 1.65 μwhich is a range used in the optical fiber network.

FIG. 6 shows the configuration of a conventional non-wavelength-dependent optical coupler. The optical coupler includes two waveguides 1a, 1b, and the waveguides 1a, 1b form directional couplers 2a, 2b and a delay path 3. Specifically, the directional couplers 2a, 2b are each formed by bringing portions of the two waveguides 1a, 1b close to each other in parallel, and the delay path 3 is formed between the two directional couplers 2a, 2b to give an optical path difference between the two waveguides 1a, 1b. The wavelength dependence of the optical coupler having the above configuration can be cancelled by adjusting parameters such as the length of the parallel portions of the directional couplers 2a, 2b, an interval (called a pitch) between the waveguides 1a, 1b the parallel portions of the directional couplers 2a, 2b, and the optical path difference in the delay path 3.

According to the technique disclosed in Non Patent Document 1, by use of the configuration of FIG. 6, the two directional couplers 2a, 2b of the optical coupler are set to have different lengths and pitches from each other. A low-wavelength-dependent optical coupler can be achieved by optimizing the length and pitch values.

According to the technique disclosed in Non Patent Document 2, by use of the configuration of FIG. 6, the two directional couplers 2a, 2b of the optical coupler are set to have the same pitch but have different lengths from each other. A low-wavelength-dependent optical coupler can be achieved by optimizing the length and pitch values.

### CITATION LIST

### Non Patent Document

Non Patent Document 1: K. Jinguji, N. Takato, A. Sugita, M. Kawachi, “Mach-Zehnder interferometer type optical waveguide coupler with wavelength-flattened coupling ratio”, Electronics Letters, Vol. 26, No. 17, 1990, pp. 1326-1327

Non Patent Document 2: Q. Chen, T. Tsuda, T. Ono, H. Urabe, H. Kawashima, K. Nara, “C-3-148 Stable high yield manufacturing of WINC with same core gap in directional couplers”, Proc. Institute of Electronics, Information and Communication Engineers General Conference, 2004, p. 322

### SUMMARY OF INVENTION

In the technique of Non Patent Document 1, the coupling efficiency of the optical coupler varies largely if the pitch deviates from its designed value in the manufacturing of the optical coupler. Hence, the optical coupler is susceptible to manufacturing errors, which causes a problem of reducing the yield and increasing the manufacturing cost. In the technique of Non Patent Document 2, the coupling efficiency of the optical coupler does not vary largely even if the pitch deviates from its designed value in the manufacturing of the optical coupler. However, the coupling length of one of the two directional couplers needs to be made longer. This causes a problem of an increase in the polarization dependent loss (PDL) because the longer coupling length increases the polarization dependence of the coupling efficiency. Accordingly, due to a trade-off between high process stability and low polarization dependence, the conventional configuration shown in FIG. 6 has difficulty achieving a non-wavelength-dependent optical coupler capable of concurrently achieving these even if the designed values of the constituents are optimized.

An optical coupler used for an optical splitter in an access network, in particular, is required to have product quality not highly susceptible to manufacturing errors (i.e., high process stability) and, at the same time, have low polarization dependence (i.e., PDL of 0.1 dB or less). The present invention aims to provide a low-wavelength-dependent optical coupler capable of concurrently achieving the high process stability and the low polarization dependence.

An aspect of the present invention is an optical coupler having two input portions and two output portions, and being configured to split an optical signal inputted into at least one of the two input portions and output the split signals from the two output portions. The optical coupler is characterized by including: a first directional coupler configured to split the optical signal from the two input portions into two; a first delay path configured to give a first phase difference between the two optical signals split by the first directional coupler; a second directional coupler configured to split the two optical signals from the first delay path into two; a second delay path configured to give a second phase difference between the two optical signals split by the second directional coupler; and a third directional coupler configured to split the two optical signals from the second delay path into two and deliver the split signals to the two output portions respectively, and is characterized in that: the first, second, and third directional couplers have the same coupling characteristic, and a value of the first phase difference and a value of the second phase difference differ from each other.

In the present invention, because the three directional couplers have the same pitch and length, the optical coupler is less susceptible to the manufacturing errors, i.e., achieves high process stability. Moreover, because the two delay paths can give the two different phase differences between the split optical signals, the optical coupler can be configured to achieve both of low polarization dependence and low wavelength dependence. Thus, the optical coupler according to the present invention is capable of performing low-wavelength-dependent optical signal split in a wide band while realizing high process stability and low PDL.

### BRIEF DESCRIPTION OF DRAWINGS

FIG. 1A is a schematic diagram of an optical coupler according to an embodiment of the present invention.

FIG. 1B is a cross-sectional view of the optical coupler according to the embodiment of the present invention.

FIG. 2 is a diagram showing a variation in the coupling efficiency of the optical coupler according to the embodiment of the present invention with respect to the wavelength.

FIG. 3 is a diagram showing a variation in the coupling efficiency of the optical coupler according to the embodiment of the present invention with respect to a parameter θ.

FIG. 4A is a diagram showing a graph of a designed value for the coupling efficiency of each directional coupler included in an optical coupler according to an example of the present invention.

FIG. 4B is a diagram showing a graph of a designed value for the coupling efficiency of the optical coupler according to the example of the present invention.

FIG. 5A is a diagram showing a graph of an actually-measured value for the coupling efficiency of the optical coupler according to the example of the present invention.

FIG. 5B is a diagram showing a graph of an actually-measured value for the through-port PDL of the optical coupler according to the example of the present invention.

FIG. 5C is a diagram showing a graph of an actually-measured value for the cross-port PDL of the optical coupler according to the example of the present invention.

FIG. 6 is a schematic diagram of a conventional optical coupler.

### DESCRIPTION OF EMBODIMENTS

An embodiment of the present invention is described below with reference to the drawings. However, the present invention is not limited to the embodiment. Note that, in the drawings to be described below, parts having the same function are given the same reference numeral and overlapping description thereof is sometimes omitted.

### Embodiment

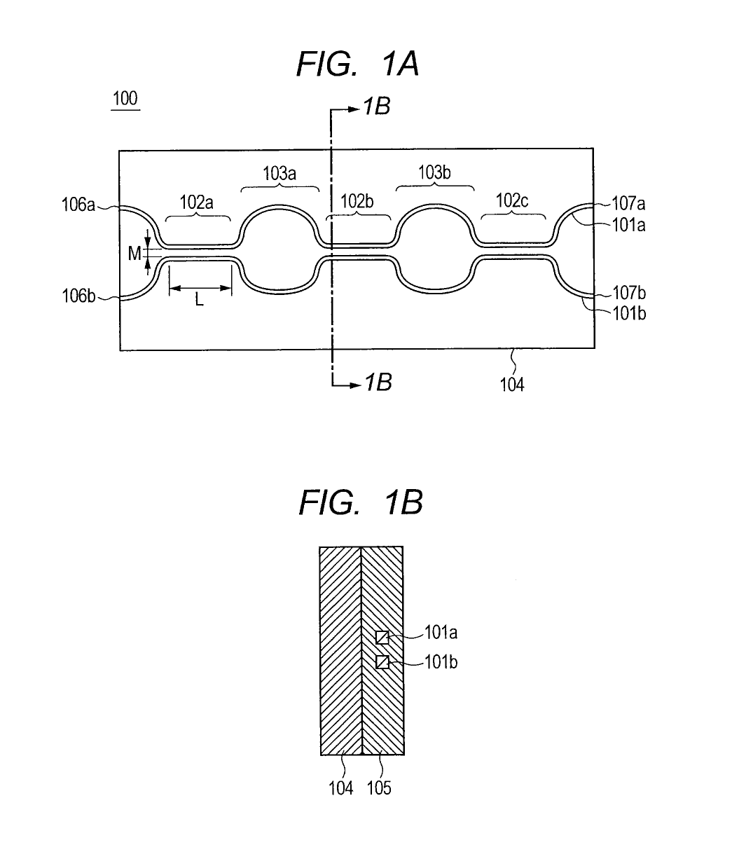

FIG. 1A shows a schematic diagram of an optical coupler 100 according to the embodiment. FIG. 1B shows a cross-sectional view of the optical coupler 100 taken along the 1B-1B line. The optical coupler 100 includes: a substrate 104; and a cladding layer being formed on the substrate 104 and having two waveguides 101a, 101b inside. The waveguides 101a, 101b are bent as shown in FIG. 1A to form three directional couplers 102a, 102b, 102c and two delay paths 103a, 103b. Specifically, the directional couplers 102a, 102b, 102c for coupling together two optical signals travelling through the respective waveguides 101a, 101b are each formed by bringing portions of the waveguides 101a, 101b close to each other in parallel. Moreover, the delay paths 103a, 103b for giving an optical path difference to the waveguides 101a, 101b are each formed by bringing portions of the waveguides 101a, 101b away from each other. The delay path 103a is provided between the directional coupler 102a and the directional coupler 102b, and the delay path 103b is provided between the directional coupler 102b and the directional coupler 102c.

One ends of the respective waveguides 101a, 101b work as input ports 106a, 106b for inputting optical signals, whereas the other ends of the respective waveguides 101a, 101b work as output ports 107a, 107b for outputting split optical signals.

The optical coupler 100 is manufactured as a planar lightwave circuit (PLC). The cladding layer 105 is formed on the substrate 104, and the waveguides 101a, 101b as a core layer are formed in the cladding layer 105. The waveguides 101a, 101b are set to have a higher refractive index than the cladding layer 105, whereby optical signals can travel through the waveguides 101a, 101b.

A quartz substrate and a silicon substrate may be used as the substrate 104. SiO₂ may be used for the cladding layer 105 and the waveguides 101a, 101b. An additive for adjusting the refractive index may be added to at least one of the cladding layer 105 and the waveguides 101a, 101b. The optical coupler 100 may be manufactured using any material other than the above materials as long as optical waveguides can be formed therefrom.

Upon input of an optical signal from at least one of the input ports 106a, 106b, the optical signal is split while traveling through the directional couplers 102a, 102b, 102c and the delay paths 103a, 103b, and the split signals are outputted from the output ports 107a, 107b.

Note that, because the delay path 103a and the delay path 103b are interchangeable, the same effect can be achieved even when the input and output are reversed. Specifically, upon input of an optical signal from at least one of the output ports 107a, 107b, the optical signal is split while traveling through the directional couplers 102a, 102b, 102c and the delay paths 103a, 103b, and the split signals are outputted from the input ports 106a, 106b.

Each of the directional couplers 102a, 102b, 102c has a portion, called a parallel portion, formed by bringing the waveguide 101a and the waveguide 101b close to each other in parallel. Here, a length in a longitudinal direction of the parallel portion of each directional coupler is defined as a coupling portion length L, and an interval between the parallel portions of the respective waveguide 101a and the waveguide 101b is defined as a pitch M. The directional couplers 102a, 102b, 102c are made in a way that has the same coupling characteristic. Having the same coupling characteristic means that values which affect the coupling efficiency, such as: the coupling portion length L and the pitch M in the parallel portions; the curvatures of the curve portions formed before and after the parallel portions; the relative refractive index difference of the waveguide constituting the directional couplers; and the width and thickness of the waveguide, are set the same among the directional couplers 102a, 102b, 102c.

Each of the delay paths 103a, 103b is formed in such a way that the waveguide 101a and the waveguide 101b have different optical path lengths from each other. As a result, a relative phase difference can be generated between two optical signals passing through the respective delay paths 103a, 103b. An optical path difference ΔL₁ of the delay path 103a and an optical path difference ΔL₂ of the delay path 103b may be set independently from each other.

In the embodiment, the optical path differences ΔL₁, ΔL₂ are set at fixed values. As another method, at least one of the delay paths 103a, 103b may be provided with means capable of variably adjusting the optical path differences ΔL₁, ΔL₂ by application of voltage, heat, or the like.

According to the present invention, the optical coupler 100 is capable of adjusting three parameters including the coupling characteristic (e.g. coupling portion length L) of each of the directional couplers 102a, 102b, 102c, the optical path difference ΔL₁ of the delay path 103a, and the optical path difference ΔL₂ of the delay path 103b. Setting these parameters appropriately can realize non-wavelength-dependent optical signal split with high process stability and low polarization dependence, which the conventional technique has had difficulty realizing.

A process of deriving parameters satisfying a desired property is shown below.

Upon input of an optical signal (whose amplitude is set at 1) into the optical coupler 100 from the input port 106a, the optical signal is split by the optical coupler 100. Then, an optical signal having an amplitude A is outputted from the output port 107a, and an output signal having an amplitude B is outputted from the output port 107b. Here, the amplitude A and the amplitude B of the outputted optical signals can be expressed with

$$( \begin{matrix}A \\ B\end{matrix} ) = {PT}_{2} {PT}_{1} P ( \begin{matrix}1 \\ 0\end{matrix} ) , \qquad ( 1 )$$

where: P corresponds to the transfer matrix of the directional couplers 102a, 102b, 102c; T₁ corresponds to the transfer matrix of the delay path 103a; and T₂ corresponds to the transfer matrix of the delay path 103b. P and Tₖ (k=1, 2) can be expressed with

$$\begin{matrix}P = ( \begin{matrix}cos θ & - j sin θ \\ - jsin θ & cos θ\end{matrix} ) , \\ {T}_{k} = ( \begin{matrix}{e}^{- j \frac{{φ}_{k}}{2}} & 0 \\ 0 & {e}^{j \frac{{φ}_{k}}{2}}\end{matrix} ) & ( 2 ) \\ θ = \frac{π}{2} \frac{{L}_{e} + L}{{L}_{C}} , \\ {φ}_{k} = \frac{2 π}{λ} {n}_{eff} Δ {L}_{k} , & ( 3 )\end{matrix}$$

where: L indicates a coupling portion length of each directional coupler; Lₑ indicates a length representing a length increased in the parallel portion when a coupling effect in the curve portions formed before and after the parallel portion of each directional coupler is equivalently taken as a coupling effect in the parallel portion; L_{c} indicates a complete coupling length of each directional coupler (i.e., a length with which coupling efficiency of 100% is achieved); λ indicates a wavelength; n_{eff} indicates the effective refractive index of each waveguide; ΔLₖ (k=1, 2) indicates the optical path differences of the delay path 103a (in the case of k=1) and the delay path 103b (in the case of k=2); and j indicates the imaginary unit.

Since the directional couplers 102a, 102b, 102c have the same characteristic, Θ is a common parameter representing the characteristic of the directional couplers 102a, 102b, 102c. In other words, the directional couplers 102a, 102b, 102c have the same parameter θ. On the other hand, φₖ (k=1, 2) is a parameter different between the delay path 103a and the delay path 103b.

The formulae are expanded for B, and assembled as the real part Re(B) and the imaginary part Im(B) as

$$Re ( B ) = - sin \frac{{φ}_{1} - {φ}_{2}}{2} {sin}^{3} θ - sin \frac{{φ}_{1} - {φ}_{2}}{2} sin {θcos}^{2} θ \\ Im ( B ) = - 2 cos \frac{{φ}_{1} + {φ}_{2}}{2} sin {θcos}^{2} θ + cos \frac{{φ}_{1} - {φ}_{2}}{2} {sin}^{3} θ - cos \frac{{φ}_{1} - {φ}_{2}}{2} sin {θcos}^{2} θ . \qquad ( 4 )$$

The coupling efficiency as the strength ratio can be obtained from the amplitude B as

|B|²=Re(B)²+Im(B)² (5)

A lot of combinations were created by changing θ, Δl₁, and ΔL₂ independently. Then, computer simulation was carried out to extract a combination which realized an optical coupler 100 having the desired property by applying each of the created combinations to the formulae (1) to (5). Here, because Lₑ and L_{c} can be deemed constants that can be uniquely decided from the wavelength, the relative refractive index difference, the pitch, and the like, the calculation was performed while changing only L regarding the parameter θ. The calculation conditions are as follows.

Relative refractive index difference: 0.4%

Width of each waveguide: 7.0 μ

Thickness of each waveguide: 7.0 μ

Pitch M: 10.8 μ

Calculated wavelengths: 1.26 μ, 1.28 μ, 1.31 μ, 1.33 μ, 1.36 μ, 1.45 μ, 1.5 μ, 1.55 μ, 1.6 μ, 1.65 μ

The extraction conditions to be satisfied were that the coupling efficiency was in a range of 0.47 to 0.53, and that the PDL was 0.1 dB or smaller at every calculation wavelength. With such extraction conditions, it is possible to select a parameter combination which achieves low wavelength dependence and low polarization dependence at the 50:50 split operation.

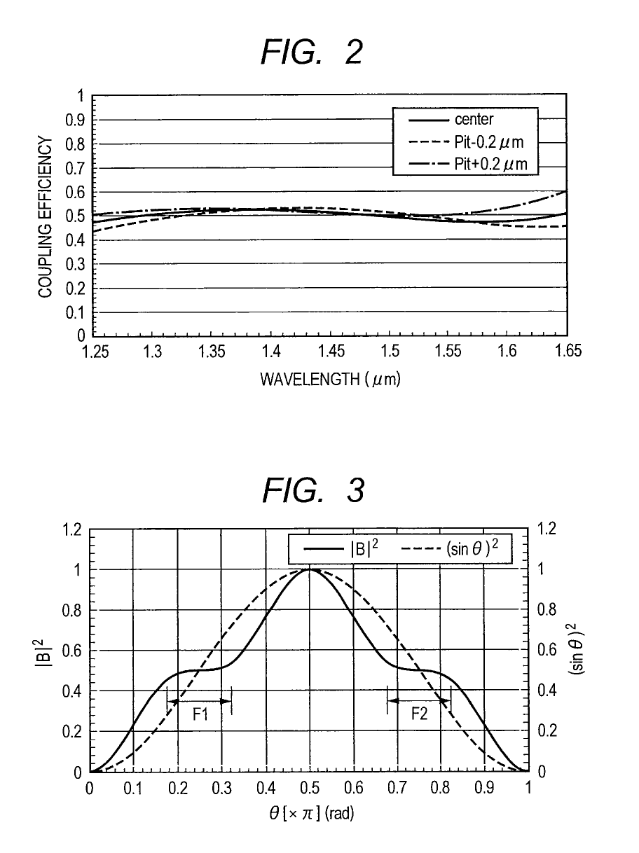

It was found from the calculation result that, in the case where the directional couplers 102a, 102b, 102c have the same value for the parameter θ, a combination where ΔL₁ is around 0 μ(equivalent to a phase difference of about 0 degree) and ΔL₂ is around 0.31 μ(equivalent to a phase difference of about 120 degrees) was able to realize the split operation with particularly high process stability. FIG. 2 shows a graph representing the coupling efficiency achieved by this combination. In FIG. 2, the horizontal axis indicates the wavelength and the vertical axis indicates the coupling efficiency. In FIG. 2, the solid line represents the coupling efficiency in the case where the pitch has a designed value, and the broken line and the chain line represent the coupling efficiency in the case where an error of 0.2 μis given to the pitch designed value. It can be learned from FIG. 2 that the coupling efficiency does not vary largely even in the case where the error is given to the pitch, i.e., the process stability is high.

Moreover, because the delay path 103a and the delay path 103b are interchangeable, the same property is achieved even in a pattern where ΔL₁ and ΔL₂ are reversed.

Note that, although the embodiment is described while employing the combination where ΔL₁ is around 0 μand ΔL₂ is around 0.31 μ, this is an example of combinations satisfying the above extraction conditions, and therefore it should be understood that there are other parameter combinations satisfying the desired property.

The relationship where ΔL₁ is around 0 μ(phase difference of 0 degree) and ΔL₂ is around 0.31 μ(phase difference of 120 degrees), which was obtained by the above simulation, is assigned to the formulae (1) to (5). As a result, the coupling efficiency |B|² of the optical coupler 100 is

|B|²=sin⁶ θ+3sin² θ cos⁴ θ (6).

FIG. 3 shows a graph representing a variation in the coupling efficiency |B|² with respect to θ, which is obtained from the formula (6). In FIG. 3, the horizontal axis indicates θ (a value divided by n), and the vertical axis indicates the coupling efficiency. In FIG. 3, the solid line indicates the coupling efficiency |B|² of the entire optical coupler 100 represented by the formula (6). As is apparent from the formulae (1) and (2), the coupling efficiency of each of the directional couplers 102a, 102b, 102c included in the optical coupler 100 is expressed with sin²θ. The coupling efficiency sin²θ of each of the directional couplers 102a, 102b, 102c is indicated by the broken line in FIG. 3.

It is found from FIG. 3 that the coupling efficiency |B|² of the entire optical coupler 100 have two flat areas F1, F2 around 0.5. The flat areas F1, F2 represent areas where the coupling efficiency is substantially constant around 0.5 even when the parameter θ of each directional coupler varies a bit. In other words, high process stability can be realized in the optical coupler 100 in which: ΔL₁ is around 0 μ(phase difference of about 0 degree); ΔL₂ is around 0.31 μ(phase difference of about 120 degrees); and e is within the flat areas F1, F2.

For example, the flat areas F1, F2 can be defined as areas in which the coupling efficiency |B|² takes a value between 0.47 and 0.53 with respect to the variation of θ. However, this definition may be changed as appropriate depending on the required process stability.

Accordingly, by making the directional couplers 102a, 102b, 102c have the same parameter θ and setting the optical path differences ΔL₁, ΔL₂ of the delay paths 103a, 103b at proper values, it is possible to form the areas in which the coupling efficiency |B|² of the optical coupler 100 is substantially constant across the certain range of θ, i.e., to create a range of θ in which the coupling efficiency |B|² can be substantially constant even in the case of the variation of θ among the directional couplers. Thus, even when the values of Lₑ, L_{c}, and L vary among the directional couplers 102a, 102b, 102c due to the manufacturing errors, the variation in the coupling efficiency |B|² of the optical coupler 100 can be reduced.

Now, let us consider conditions for allowing θ to be included in the flat areas F1, F2.

As can be understood from FIG. 3, the flat areas F1, F2 for the coupling efficiency |B|² of the optical coupler 100 are each formed before and after a point at which the coupling efficiency sin²θ of each directional coupler is 0.5. This is also supported by the fact that the inclination of the coupling efficiency |B|² of the optical coupler 100 (i.e., the differentiation of the formula (6)) is 0 when sin²θ is 0.5.

In sum, the coupling efficiency sin²θ of each directional coupler needs to be 0.5 in the use wavelength band of the optical coupler 100, specifically, at any of the wavelengths of 1.26 um to 1.65 μ. To put it the other way round, θ cannot be set to be included in the flat areas F1, F2 in the use wavelength band (i.e., the inclination of the coupling efficiency |B|² of the optical coupler 100 never becomes 0 in the use wavelength band) if the coupling efficiency sin²θ of each directional coupler is not 0.5 in the use wavelength band. Accordingly, the optical coupler 100 having θ included in the flat areas F1, F2 can be manufactured if the parameter θ of each directional coupler is set in such a way that the coupling efficiency sin²θ of each of the directional couplers 102a, 102b, 102c is 0.5 (50%) at any wavelength in the use wavelength band.

The present invention is not limited to the case where ΔL₁ is 0 μ(phase difference of 0 degree) and ΔL₂ is 0.31 μ(phase difference of 120 degrees). High process stability can be achieved as long as the coupling efficiency |B|² of the optical coupler 100 has the flat areas in which: the coupling efficiency is substantially constant around 0.5 with respect to the variation of θ; and the parameter θ of each directional coupler of the optical coupler 100 is included in the flat areas.

### Example

An optical coupler 100 according to the present invention was manufactured and its split operation was checked. The manufacturing conditions were as follows.

Substrate: Quartz-based PLC

Relative refractive index difference: 0.4%

Width of each waveguide: 7.0 μ

Thickness of each waveguide: 7.0 μ

Pitch M: 10.8 μ

Coupling portion length L: 290 μ

Optical path difference ΔL₁: −0.01 μ(phase difference: about −3.6 degrees)

Optical path difference ΔL₂: 0.315 μ(phase difference: about 113 degrees)

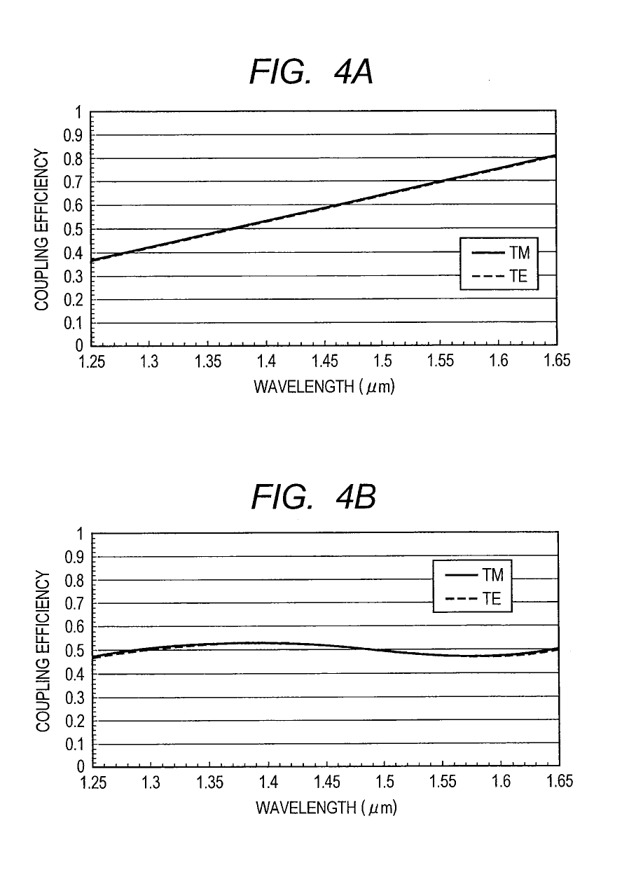

FIG. 4A shows a graph representing a designed value for the coupling efficiency of each directional coupler included in the optical coupler 100 according to the example. In FIG. 4A, the horizontal axis indicates the wavelength and the vertical axis indicates the coupling efficiency. The solid line indicates the TM mode and the broken line indicates the TE mode. As can be learned from FIG. 4A, each directional coupler is designed in such a way that its coupling efficiency sin²θ is 50% at a wavelength of about 1.39 μin the use wavelength band.

FIG. 4B shows a graph representing a designed value for the coupling efficiency of the optical coupler 100 according to the example. In FIG. 4B, the horizontal axis indicates the wavelength and the vertical axis indicates the coupling efficiency. The solid line indicates the TM mode and the broken line indicates the TE mode. As can be learned from FIG. 4B, the optical coupler 100 is designed in such a way that its coupling efficiency never varies largely over the entire use wavelength band. Moreover, the polarization dependence between the TM/TE modes is hardly observed.

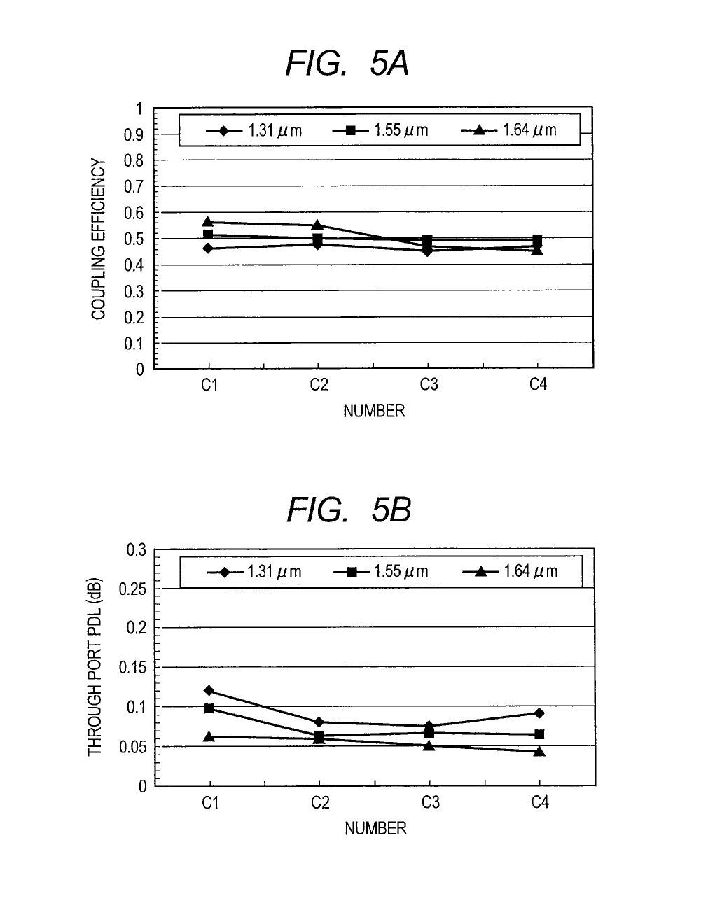

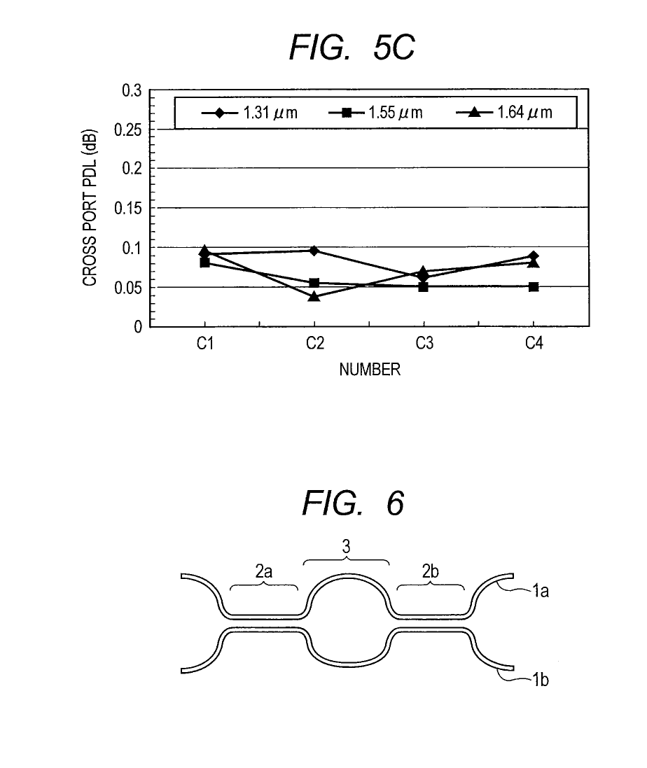

FIGS. 5A to 5C show a result of measuring the coupling efficiency and the PDL of each of optical couplers 100 according to the example actually made. In each of FIGS. 5A to 5C, the horizontal axis indicates numbers C1 to C4 of the four manufactured samples. The measurement on the coupling efficiency and the PDL was conducted using optical signals having wavelengths of 1.31 μ, 1.55 μ, and 1.64 μ, respectively.

In FIG. 5A, the vertical axis indicates the coupling efficiency. It can be learned from FIG. 5A that the coupling efficiency of each sample is about 0.5 at every wavelength. In FIG. 5B, the vertical axis indicates the PDL of an optical signal outputted from the through port, i.e., from the same waveguide into which the optical signal has been inputted. It can be learned from FIG. 5B that the coupling efficiency of each sample is about 0.1 or smaller at every wavelength. In FIG. 5C, the vertical axis indicates the PDL of an optical signal outputted from the cross port, i.e., from a different waveguide from a waveguide into which the optical signal has been inputted. It can be learned from FIG. 5C that the coupling efficiency of each sample is about 0.1 or smaller at every wavelength. Thus, it was confirmed that the present invention can realize a non-wavelength-dependent optical coupler with high process stability and low polarization dependence.

The present invention is not limited to the above embodiment but can be modified as appropriate without departing from the gist of the present invention.

1. An optical coupler having two input portions and two output portions, and being configured to split an optical signal inputted into at least one of the two input portions and output the split signals from the two output portions, the optical coupler comprising:
a first directional coupler configured to split the optical signal from the two input portions into two;
a first delay path configured to give a first phase difference between the two optical signals split by the first directional coupler;
a second directional coupler configured to split the two optical signals from the first delay path into two;
a second delay path configured to give a second phase difference between the two optical signals split by the second directional coupler; and
a third directional coupler configured to split the two optical signals from the second delay path into two and deliver the split signals to the two output portions, respectively, wherein
the first, second, and third directional couplers have the same coupling characteristic, and
a value of the first phase difference and a value of the second phase difference differ from each other.

2. The optical coupler according to claim 1, wherein
the first, second, and third directional couplers each have coupling efficiency of 50% at any wavelength in a wavelength band in which the optical coupler is used,
a value of one of the first and second phase differences is about 0 degree, and
a value of the other of the first and second phase differences is about 120 degrees.

3. The optical coupler according to claim 2, wherein the wavelength band in which the optical coupler is used is 1.26 μto 1.65 μ, both inclusive.

4. The optical coupler according to claim 1, wherein the optical coupler is a planar lightwave circuit (PLC).

5. The optical coupler according to claim 1, wherein the coupling characteristic of each of the first, second, and third directional couplers is expressed with 0 which is defined by the following formula (7)
$$θ = \frac{π}{2} \frac{{L}_{e} + L}{{L}_{C}} , \qquad ( 7 )$$
where: L and L_{c} indicate a coupling portion length and a complete coupling length, respectively, of each of the first, second, and third directional couplers; and Lₑ indicates a length representing a length increased in a parallel portion when a coupling effect produced by portions before and after the parallel portion of each of the first, second, and third directional couplers is equivalently taken as a coupling effect in the parallel portion.

6. The optical coupler according to claim 5, wherein
coupling efficiency of the optical coupler is expressed with a function of θ,
the function has a flat area in which the coupling efficiency is substantially constant around 0.5 with respect to a variation of θ, and
θ is included in the flat area of the function.

7. The optical coupler according to claim 6, wherein the flat area of the function is an area in which the coupling efficiency is 0.47 to 0.53, both inclusive, with respect to the variation of θ.
